(19) United States
(12) Patent Application Publication
(10) Pub. No.: US 2006/0165140 A1
(43) Pub. Date: Jul. 27, 2006

(54) Temperature compensated laser system

(76) Inventors: Shan Chong Tan, Selangor (MY); Chin Yun Lee, Penang (MY); Bernard Lye Hock Chan, Bayan Lepas (MY)

Correspondence Address: AVAGO TECHNOLOGIES, LTD., P.O. BOX 1920, DENVER, CO, 80201-1920, US

(21) Appl. No.: 11/046,363

(22) Filed: Jan. 27, 2005

(51) Int. Cl. H01S 3/00; H01S 3/04

(52) U.S. Cl. 372/33; 372/34

(57) ABSTRACT

A Temperature Compensated Laser System (“TCLS”) for producing a temperature compensated laser drive current for a laser in an optical navigation device is described. The TCLS may include a controller in signal communication with an adjustable current source, wherein the adjustable current source produces the temperature compensated laser drive current. The TCLS may also include a measurement module in signal communication with the controller and the adjustable current source, wherein the controller adjusts the temperature compensated laser drive current produced by the adjustable current source responsive to a change in temperature sensed by the TCLS.

### BACKGROUND OF THE INVENTION

Non-mechanical tacking devices, such as computer mice, are quickly growing in popularity worldwide. Many of these non-mechanical tracking devices utilize optical navigation technology that measures the changes in position of the non-mechanical tracking devices by optically acquiring sequential surface images and mathematically determining the direction and magnitude of the movement.

As an example, in FIG. 1, a block diagram 100 of an example of a known implementation of an optical navigation device 102 above a navigation surface 104 is shown. The optical navigation device 102 may be a non-mechanical tracking device such as an optical mouse. Generally, optical navigation technology involves capturing an image on the navigation surface 104 and then analyzing and tracking the motion of microscopic texture or other features on the navigation surface 104 under the optical navigation device 102. In general, the optical navigation device 102 depends on tracking the navigation surface 104 detail because most navigation surfaces 104 are microscopically textured. When these surface textures are illuminated 106 by a light source such as a light emitting diode (“LED”) in an emitter module 108, a pattern of highlights and shadows is revealed at point of illumination 110 on the navigation surface 104. The optical navigation device 102 then “watches” the surface details of the navigation surface 104 move by imaging 112 the navigation surface 104 details at the point of illumination 110 onto a detector module 114 in the optical navigation device 102. The detector module 114 may be part of a navigation integrated circuit (“IC”) 116 located within the optical navigation device 102. The navigation IC 116 may also include a navigation engine 118 where the navigation engine 118 is a device capable of receiving imaging information from the detector module 114 and, in response, determining the position of the optical navigation device 102.

The optical navigation device 102 may also be implemented as a laser optical navigation device. As an example of a laser optical navigation device, a Vertical Cavity Semiconductor Emitting Laser (“VCSEL”) may be utilized as the light source in the emitter module 108 to illuminate the point of illumination 110 for navigation surface 104. A VCSEL is a semiconductor micro-laser diode that emits light in a cylindrical beam vertically from the surface of a fabricated wafer, and offers advantages in both performance and cost when compared to other semiconductor lasers such as the edge-emitting lasers. The VCSELs are cheaper to manufacture in quantity because VCSELs may be fabricated efficiently using standard microelectronic fabrication methods allowing integration of VCSELs on-board with other components without requiring pre-packaging. Additionally, VCSELs are easier to test, and are more efficient. Moreover, VCSELs requires less electrical current to produce a given coherent energy output and VCSELs emit a narrow, more nearly circular beam than traditional edge emitters.

Because VCSELs are lasers, VCSELs suffer from the same problems associated with lasers such that VCSEL light output characteristics are more sensitive to temperature change then LEDs. FIGS. 2, 3 and 4 show examples of typical VCSEL output power variations versus current and temperature. In FIG. 2, a graphical representation of a plot 200 of a typical laser power response 202 in milliwatts (“mW”) versus both temperature 204 in Celsius (“C”) and laser current 206 in milliamps (“mA”). In this example, if the laser current is maintained constant across temperature (as shown in curve 208), the typical laser optical power (as shown in curve 210) tends to shift up/down at both temperature extremes having a low power point 212 and a high power point 214. In this example, the ideal laser optical power level 216 is shown as the intersection of the constant laser current curve 208 and the laser output power curve 210.

The VCSEL change in laser power is the result of the sensitivity to temperature of the VCSEL parameters that include threshold current (“Iₜₕ”) and slope efficiency (“SE”). In general, the laser power output may be hazardous to the eyes of a user if the laser power output is greater than approximately 800 micro-watts (“μW”). Additionally, the optical navigation device 102, FIG. 1, may not track properly if the laser power output is below approximately 80 μW.

Similar to FIG. 2, in FIG. 3, a graphical representation of a plot 300 of a typical laser power response 302 versus both temperature 304 and laser current 306. In this example, if the laser current is maintained constant across temperature (as shown in curve 308), the typical laser optical power (as shown in the curve having a first laser optical power curve between 0 and 25C 310 and a second laser optical power curve between 25 and 50C 312) tends to shift up at both temperature extremes having a first high power point 314 and a second high power point 316. In this example, the ideal laser optical power level 318 is shown as the intersection of the constant laser current curve 308 and the laser output power curve 310 and 312. The response of FIG. 3 is different from FIG. 2 because generally the temperature response of many VCSELs is manufacturer dependent.

Again similar to FIGS. 2 and 3, in FIG. 4, a graphical representation of a plot 400 of a typical laser power response 402 versus both temperature 404 and laser current 406. Unlike FIG. 3, in this example, if the laser current is maintained constant across temperature (as shown in curve 408), the typical laser optical power (as shown in the curve having a first laser optical power curve between 0 and 25C 410 and a second laser optical power curve between 25 and 50C 412) tends to shift down at both temperature extremes having a first low power point 414 and a second low power point 416. In this example, the ideal laser optical power level 418 is shown as the intersection of the constant laser current curve 408 and the laser output power curve 410 and 412. Again, the response of FIG. 4 is different from both FIGS. 2 and 3 because generally the temperature response of many VCSELs is manufacturer dependent.

Unfortunately, many optical navigation devices (such as computer mice) operate in uncontrolled environments that include an end user's home or office. These optical navigation devices may be utilized by people (including children) that do not appreciate the safety concerns associated with utilizing a laser such as the danger of aiming a laser beam into a human eye (i.e., when a laser enabled optical computer mouse is turned upside down by a user). Therefore, in order to produce an optical navigation device that is safe for uncontrolled environments, the VCSEL's light output must not exceed predetermined eye-safety requirements.

Unfortunately, in many uncontrolled environments the temperature of operation may vary in ways that would affect the VCELs potentially producing light outputs that exceed the eye-safety requirements causing a potential hazard to end users. Therefore, there is a need for a system and method capable of compensating the VCSEL current for temperature variations.

### SUMMARY

A Temperature Compensated Laser System (“TCLS”) for producing a temperature compensated laser drive current for a laser in an optical navigation device is described. The TCLS may include a controller in signal communication with an adjustable current source, wherein the adjustable current source produces the temperature compensated laser drive current. The TCLS may also include a measurement module in signal communication with the controller and the adjustable current source, wherein the controller adjusts the temperature compensated laser drive current produced by the adjustable current source responsive to a change in operating temperature of the TCLS as sensed by the TCLS.

In an example of operation, the TCLS performs a process that compensates for temperature variations in the optical navigation device that has a laser. The process may include measuring a change of operating temperature of the TCLS within the optical navigation device and producing a temperature compensated laser drive current in response to the change in temperature.

Other systems, methods and features of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following figures. The components in the figures are not necessarily to scale, emphasis instead being placed upon illustrating the principles of the invention. In the figures, like reference numerals designate corresponding parts throughout the different views.

FIG. 1 is a functional block diagram of an example of an implementation of a known optical navigation device.

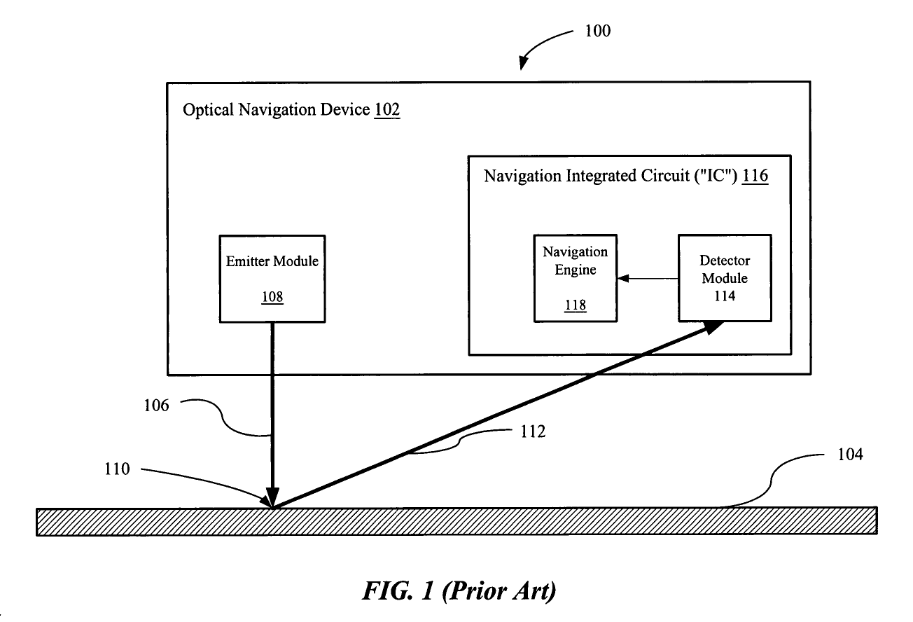

FIG. 2 is a graphical representation of an example of a plot of a typical laser power response in milliwatts (“mW”) versus both temperature in Celsius (“C”) and laser current in milliamps (“mA”) for a Vertical Cavity Semiconductor Emitting Laser (“VCSEL”).

FIG. 3 is a graphical representation of another example of a plot of a typical laser power response versus both temperature and laser current for a VCSEL.

FIG. 4 is a graphical representation of yet another example of a plot of a typical laser power response versus both temperature and laser current for a VCSEL.

FIG. 5 is a block diagram of an example of an implementation of a Temperature Compensated Laser Driver (“TCLD”) within an optical navigation device.

FIG. 6 is a functional block diagram of an example of an implementation of a Temperature Compensated Laser System (“TCLS”) within the TCLD shown in FIG. 5.

FIG. 7 is a graphical representation of a plot of a temperature compensated laser power response versus both temperature and laser current for a VCSEL having an uncompensated laser power response shown in FIG. 2 in accordance with the present invention.

FIG. 8 is a graphical representation of another plot of a temperature compensated laser power response versus both temperature and laser current for a VCSEL having an uncompensated laser power response shown in FIG. 3 in accordance with the present invention.

FIG. 9 is a graphical representation of yet another plot of a temperature compensated laser power response versus both temperature and laser current for a VCSEL having an uncompensated laser power response shown in FIG. 4 in accordance with the present invention.

FIG. 10 is a flowchart diagram of an example of a process performed by TCLS shown in FIG. 5.

FIG. 11 is a flowchart 1100 of an example of a process preformed by the TCLS is shown in FIG. 5 for determining whether TCLS is properly compensating for changes in temperature.

FIG. 12 is a flowchart diagram of another example of a process performed by TCLS shown in FIG. 5.

### DETAILED DESCRIPTION

In the following description, reference is made to the accompanying drawings that form a part hereof, and which show, by way of illustration, a specific embodiment in which the invention may be practiced. Other examples of implementation may be utilized and structural changes may be made without departing from the scope of the present invention.

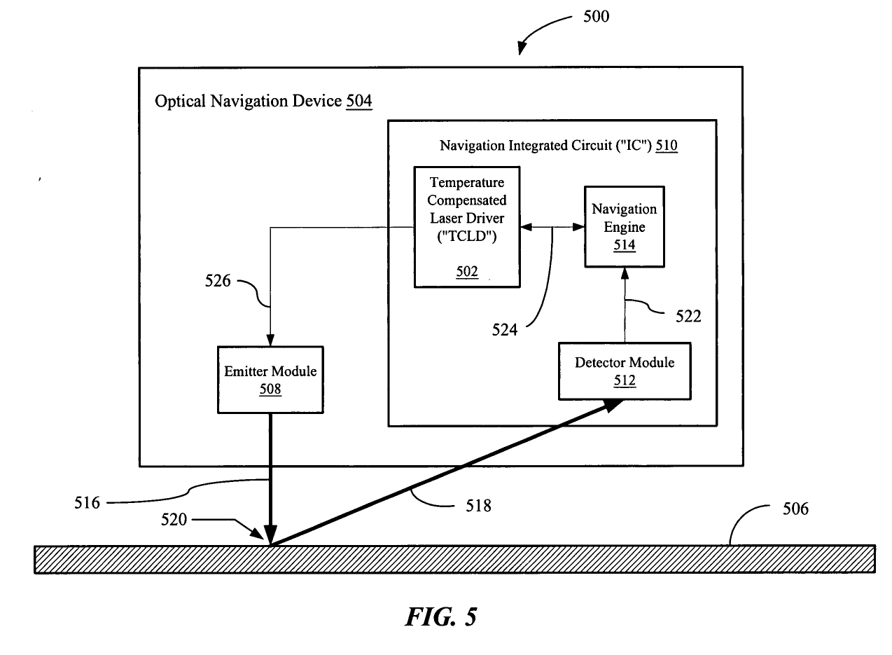

In FIG. 5, a block diagram 500 of an example of an implementation of a Temperature Compensated Laser Driver (“TCLD”) 502 within an optical navigation device 504 is shown. The optical navigation device 504 may be positioned above a navigation surface 506. As an example, the optical navigation device 504 may also include an emitter module 508 and the TCLD 502 may be part of a navigation integrated circuit (“IC”) 510. The navigation IC 510 may also include a detector module 512 and a navigation engine 514.

The emitter module 508 may include optics (not shown) capable of producing emitted optical radiation 516 from the emitter module 508 to the navigation surface 506. Additionally, the detector module 512 may include optics (not shown) capable of detecting reflected optical radiation 518 from the navigation surface 506, where the reflected optical radiation 518 is a result of the emitted optical radiation 518 being reflected off the navigation surface 506.

The emitted optical radiation 516 and reflected optical radiation 518 may be visible, infrared, and/or ultraviolet light radiation. The emitter module 508 includes a laser (not shown) such as a semiconductor edge-emitting laser or a Vertical Cavity Semiconductor Emitting Laser (“VCSEL”), and the detector module 512 may include an array of photo-detectors (not shown) such as photo-diodes.

The optical navigation device 504 may be a non-mechanical tracking device such as, for example, an optical mouse. In an example of operation, the optical navigation device 504 captures an image on the navigation surface 506 and then analyzes and tracks the motion of the microscopic textures or other features on the navigation surface 506 under the optical navigation device 504. These surface textures are illuminated 516 by a light source such as a light emitting diode (“LED”) or laser in an emitter module 508 and a pattern of highlights and shadows is revealed at a point of illumination 520 on the navigation surface 506. The optical navigation device 504 then “watches” the surface details of the navigation surface 506 move by imaging (via reflected optical radiation 518) the surface details at the point of illumination 520 onto the detector module 512. The detector module 512 may be optionally integrated as part of the navigation IC 510 or it may be a separate device from the navigation IC 510.

The navigation IC 510 may also include the navigation engine 514, where the navigation engine 514 is a device capable of receiving imaging information from the detector module 512, via signal path 522, and, in response, determining the position of the optical navigation device 504 relative to the navigation surface 506. The navigation engine 514 is a device, such as a digital signal processor (“DSP”), capable of performing image-processing manipulation, including prediction, correlation, and interpolation of the imaging information captured by the detector module 512 in order to determine direction and distance of motion of the optical navigation device 504 relative to the navigation surface 506.

The navigation engine 514 may be in signal communication with the TCLD 502 via signal path 524 and the TCLD 502 may also be in signal communication with the emitter module 508 via signal path 526. The TCLD 502 include an adjustable current source (not shown), output laser driver (not shown), and Temperature Compensated Laser System (not shown). The TCLD 502 is a device capable of providing the laser (not shown) in the emitter module 508 with a current that has been compensated for temperature variations such that the power output of the laser is approximately constant across temperature variations. The TCLD 502 may both send and receive information, via signal path 524, to the navigation engine 514 indicative of temperature and/or laser drive current levels.

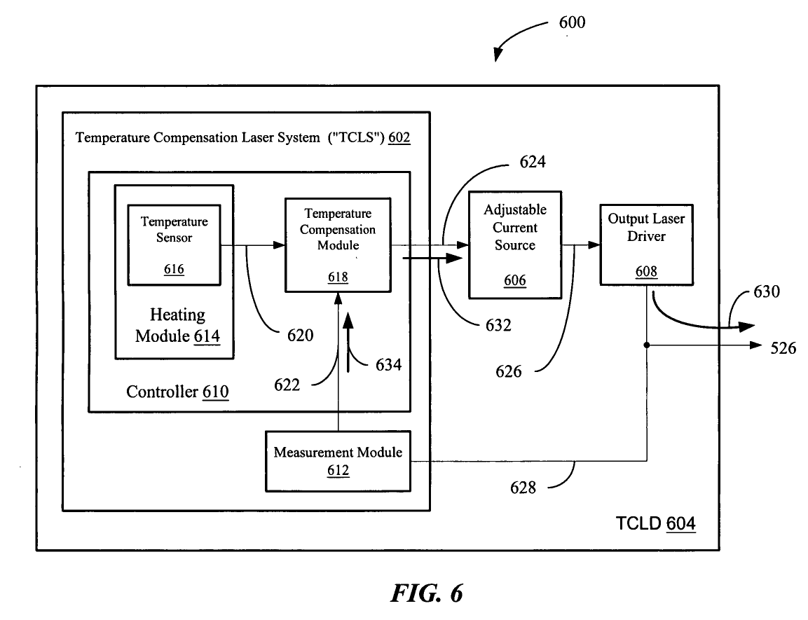

FIG. 6 is a block diagram 600 of an example of an implementation of a Temperature Compensated Laser System (“TCLS”) 602 within the TCLD 604 shown in FIG. 5. The TCLD 604 may include an adjustable current source 606, output laser driver 608, and the TCLS 602. As an example, the TCLS 602 may include a controller 610 and measurement module 612. The controller 610 may include a heating module 614 (having a temperature sensor 616) and a temperature compensation module 618. The temperature compensation module 618 may be in signal communication with the temperature sensor 616, measurement module 612, and adjustable current source 606, via signal paths 620, 622, and 624, respectively. The output laser driver 608 may be in signal communication with the adjustable current source 606, measurement module 612, and emitter module 508, FIG. 5, via signal paths 626, 628, and 526, respectively, where signal path 628 is a tapped signal from the output laser driver signal 630 being sent to the emitter module 508, FIG. 5 via signal path 526.

The heating module 614 may be any type of circuitry (not shown) or a device (not shown) capable of heating the TCLS 602 in order to raise the temperature of operation (also known as the “operating temperature”) of the TCLD 604. The heating module 614 may include the temperature sensor 616 and, as an example, the heating module 614 may be implemented by sourcing a high current through a low resistive path such as a thermal resistance. It is appreciated by those skilled in the art that the amount of heat produced would be proportional to the amount of power produced by Ohm's law where the amount of power is equal to the current squared multiplied by the resistance value of the thermal resistance as described by the well known relationship P=I²R. When the heating module 614 is turned off, the temperature sensor 616 effectively senses the operating temperature change around the TCLS 602 within the navigation device 504. When the heating module 614 is turned on, the heating module 614 is capable of increasing the operating temperature of the TCLS 602 such that the increase in operating temperature of the TCLS 602 would simulate an increase in temperature of the environment of the TCLD 604. This environment includes the operating temperature within the navigation IC 510 and/or the optical navigation device 504.

The temperature sensor 616 is capable of notifying the temperature compensation module 618, via signal path 620, of a change of operating temperature within the TCLS 602 within the navigation device 504. Optionally, the operating temperature around the temperature sensor may be intentionally raised by the heating module 614 to simulate an increase in operating temperature of the navigation IC 510 and/or the navigation device 504. As an example, the temperature sensor 616 may be implemented utilizing the forward bias voltage of a diode (not shown).

The temperature compensation module 618 receives the change of temperature information from the temperature sensor 608 and in response compensates the laser drive current provided to the laser (not shown) in the Emitter Module 508, FIG. 5. The temperature compensation module 618 may compensate the laser drive current by a predefined value that maintains the laser drive current within a range of values that result in the output power of the laser being within a desired range of values. The temperature compensation module 618 may be implemented with an operation amplifier (“op-amp”) (not shown) driven in either a non-inverting or inverting configuration with a resistive network (not shown) having a resistor value set to the desired rate of compensation. The temperature compensation module 618 then passes a temperature compensation value 632, via signal path 624, to the adjustable current source 606.

The adjustable current source 606 may be any current source type circuit capable of controlling the amount of current feed to the laser in the emitter module 508, FIG. 5, based on the received temperature compensation value 632 from the temperature compensation module 618. The adjustable current source 606 may be implemented as any well known controllable current source that may include, for example, op-amps and current mirror circuits. The adjustable current source 606 produces a current source output that is passed, via signal path 626, to the output laser driver 608. The output laser driver 608 is an optional driver circuit capable of receiving the current source output and producing output laser driver signal 630 that is passed to the laser in the emitter module via the signal path 526. As an example, the output laser driver 608 may be a current buffer.

The measurement module 612 is any device, circuitry or software capable of measuring the output laser driver signal 630, via signal path 628, and in response producing a measurement output signal 634 having measurement data that is passed to the temperature compensation module 618 in the controller 610 via signal path 622.

The controller 610 may include a memory module (not shown) and an optional software module (not shown). The controller 610 may be any type of circuitry, software module, microcontroller, microprocessor, digital signal processor, application specific integrated chip (“ASIC”) or other type of device capable of receiving the measurement output signal 634 from the measurement module 612 and determining whether to adjust the laser drive current in the adjustable current source 606 by sending the temperature compensation value 632 to the adjustable current source 606 via signal path 624. Based on the complexity of the controller 610, the controller 610 may be a hardwired device or a programmable device capable of running programmed software from the software module (not shown) and storing data in the memory module (not shown).

In an example of operation, the TCLS 602 may first measure the temperature of operation of the TCLS 602 within the TCLD 604, via temperature sensor 616, to establish an initial temperature of operation and then at different times measure the operating temperature again to establish a new temperature of operation. The TCLS 602 may then determine the measured change of temperature of the TCLS 602. In response to the change of temperature, the TCLS 602 may compensate the laser drive current 526 of the laser in a predetermined fashion that is responsive to the change in temperature for the laser.

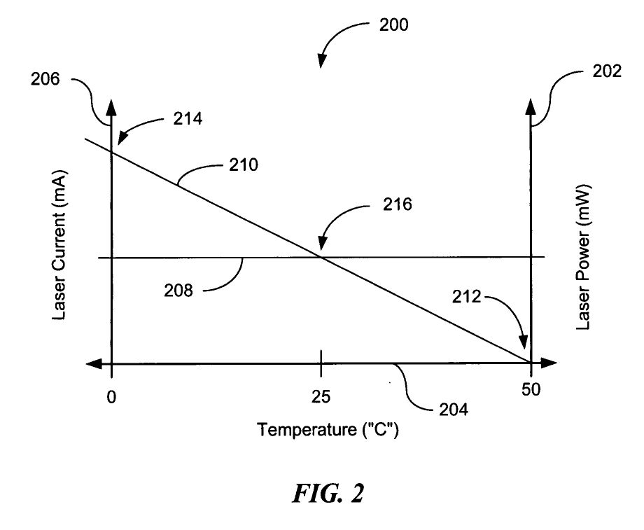

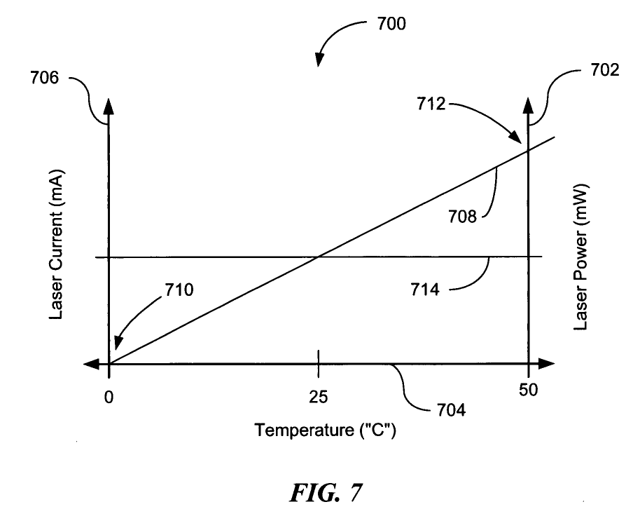

FIGS. 7, 8 and 9 show examples of VCSEL output power variations versus current and temperature in accordance with the present invention. In FIG. 7, a graphical representation of a plot 700 of a temperature compensated laser power response 702 in milliwatts versus both temperature 704 in Celsius and laser current 706 in milliamps is shown for a VCSEL having the uncompensated response shown in FIG. 2. In this example, as the operating temperature changes, the temperature sensor 616 senses the change and feeds the information to the temperature compensation module 618, which adjusts the current source 606 output in response to the temperature change. As a result, the magnitude of current source is a compensated laser drive current that may be described by the compensated laser drive current curve 708. Generally, the compensated laser drive current 708 shifts from a low current point 710 at low temperature (such as at 0C) to a high current point 712 at a high temperature (such as at 50C). In response to the compensated laser drive current 708, the temperature compensated laser power 714 of the VCSEL is approximately constant. The compensated laser drive current may be predefined as a current response that is compensated for the laser power output response of a VCSEL across temperature. Generally, the predefined compensated laser drive current response is VCSEL manufacturer specific.

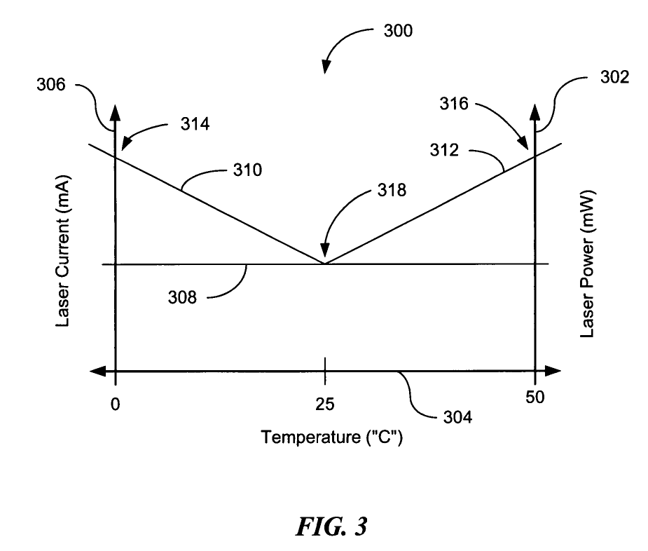

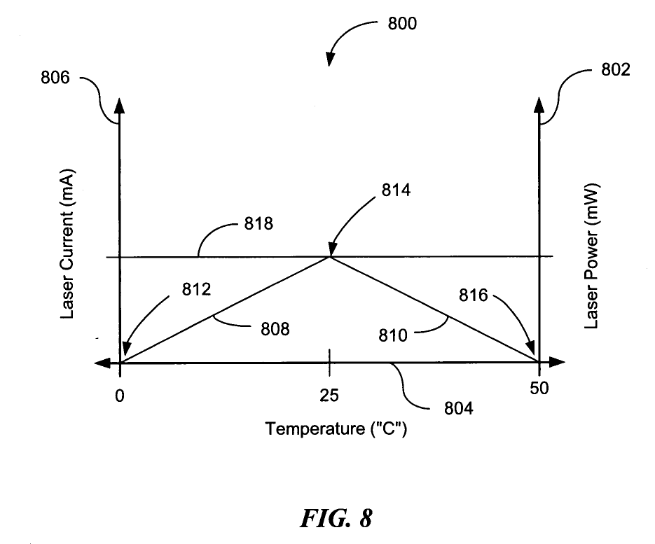

Similar to FIG. 7, in FIG. 8, a graphical representation of a plot 800 of a typical laser power response 802 versus both temperature 804 and laser current 806 is shown for a VCSEL having the uncompensated response shown in FIG. 3. Similar to FIG. 7, in this example, as the operating temperature changes, the temperature sensor 616 senses the change and feeds the information to the temperature compensation module 618, which adjusts the output of the adjustable current source 606 in response to the temperature change. As a result, the magnitude of current source is a compensated laser drive current that may be described by the compensated laser drive current (as shown in the curve having a first compensated laser drive current curve between 0 and 25C 808 and a second compensated laser drive current curve between 25 and 50C 810). In this example, the compensated laser drive current 808 and 810 shifts from a low current point 812 at low temperature (such as at 0C) to a high current point 814 (such as at 25C) and then to second low current point 816 at a high temperature (such as at 50C). In response to the compensated laser drive current 808 and 810, the temperature compensated laser power 818 of the VCSEL is approximately constant. Again, the compensated laser drive current 808 and 810 may be predefined as a current response that is compensated for the laser power output response of a VCSEL across temperature, where the predefined compensated laser drive current response is VCSEL manufacturer specific.

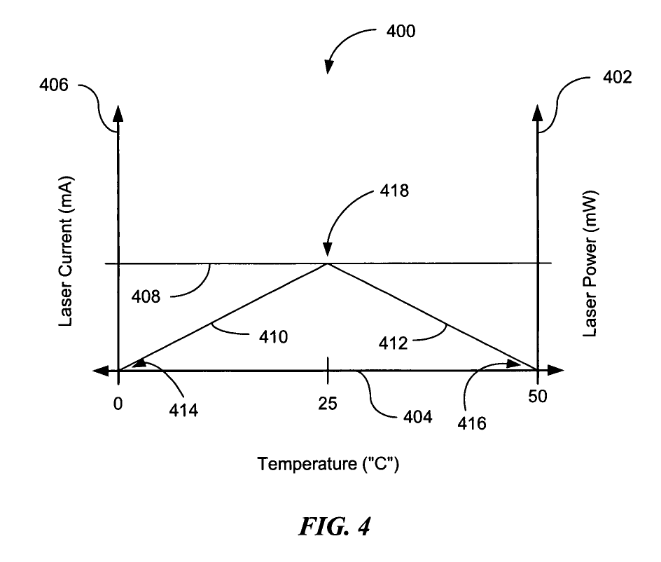

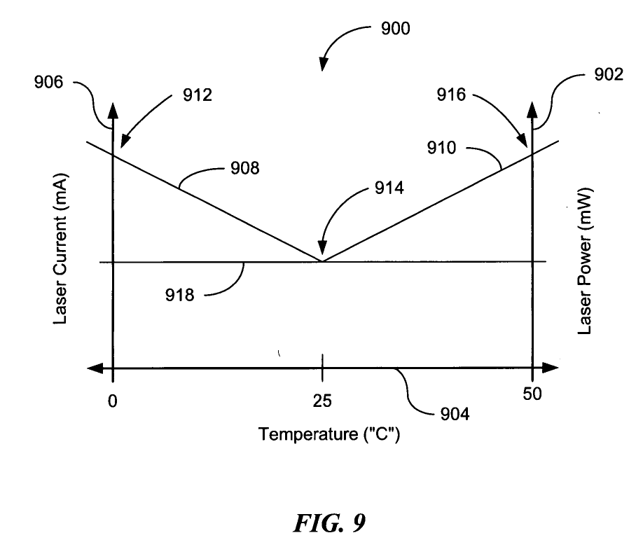

Again similar to FIGS. 7 and 8, in FIG. 9, a graphical representation of a plot 900 of a typical laser power response 902 versus both temperature 904 and laser current 906 is shown for a VCSEL having the uncompensated response shown in FIG. 4. Similar to FIGS. 7 and 8, in this example, as the temperature changes the temperature sensor 616 senses the change and feeds the information to the temperature compensation module 618, which adjusts the output of the adjustable current source 606 in response to the temperature change. As a result, the magnitude of current source is a compensated laser drive current that may be described by the compensated laser drive current (as shown in the curve having a first compensated laser drive current curve between 0 and 25C 908 and a second compensated laser drive current curve between 25 and 50C 910). In this example, the compensated laser drive current 908 and 910 shifts from a first high current point 912 at low temperature (such as at 0C) to a low current point 914 (such as at 25C) and then to second high current point 916 at a high temperature (such as at 50C). In response to the compensated laser drive current 908 and 910, the temperature compensated laser power 918 of the VCSEL is approximately constant. Again, the compensated laser drive current 908 and 910 may be predefined as a current response that is compensated for the laser power output response of a VCSEL across temperature, where the predefined compensated laser drive current response is VCSEL manufacturer specific.

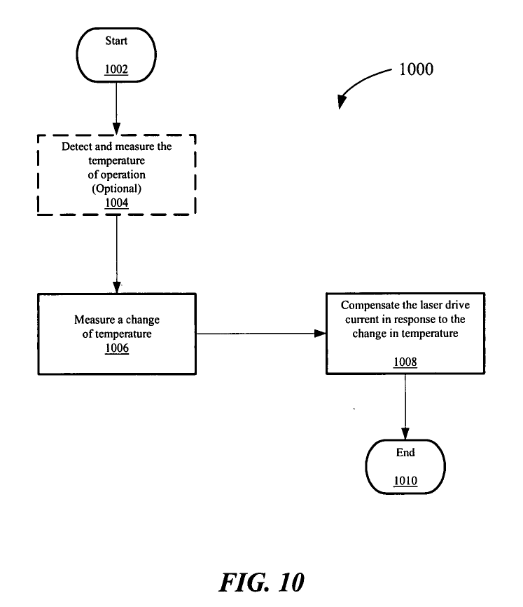

In FIG. 10 a flowchart 1000 of an example of a process preformed by the TCLS 502 is shown. In FIG. 10, the process begins at step 1002 and in step 1004 the TCLS 502 optionally measures the operating temperature of the TCLS 602 within the TCLD 604 of the navigation device 504 to establish an initial temperature of operation. Step 1004 is optional because TCLS 602 may already have a priori knowledge of the initial temperature of operation. The TCLS 602 then detects and measures if there is a change of temperature in the operating environment of TCLS 602 in step 1006. The measurement of the temperature change may include measuring a second temperature of operation and comparing the second temperature of operation to the initial temperature of operation. Once a change of temperature is detected and measured, the TCLS 602 compensates the laser drive current in response to the measured change in temperature in step 1008. The TCLS 602 may compensate the laser drive current by driving a current source to produce the compensated laser drive current based on predetermined values determined by the type of laser utilized. The process then ends in step 1010.

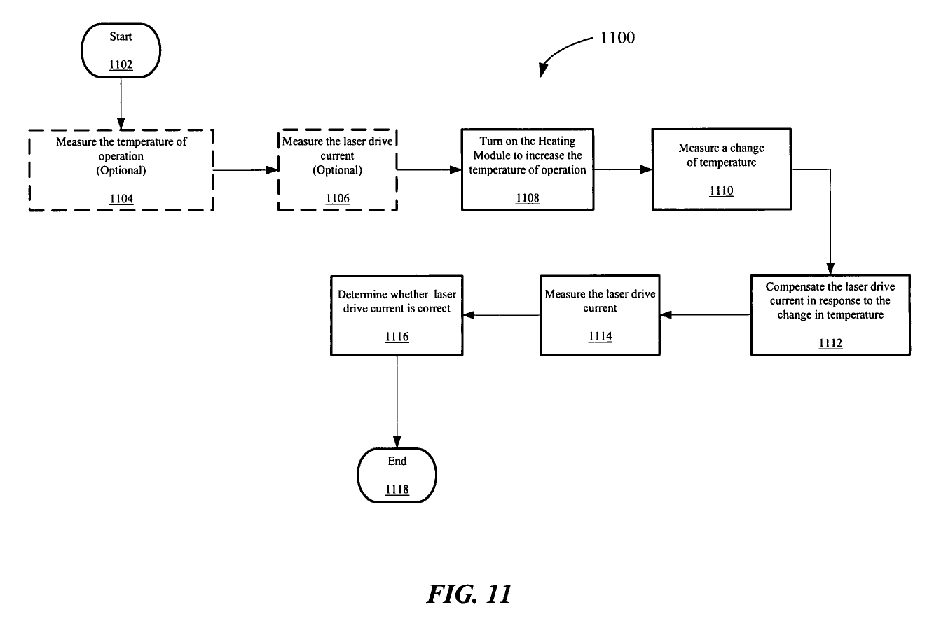

Additionally, in FIG. 11 a flowchart 1100 of an example of a process preformed by the TCLS 602 is shown for determining whether TCLS 602 is properly compensating for changes in temperature. In FIG. 11, the process begins at step 1102 and in optional step 1104 the TCLS 602 optionally measures the temperature of operation of the heating module to establish an initial temperature of operation. Similarly, in optional step 1106, the TCLS 602 may optionally measure the laser drive current with the measurement module 612 to establish an initial laser drive current value. Both steps 1104 and 1106 are optional because TCLS 602 may already have a priori knowledge of the initial temperature of operation and the initial laser drive current value. The TCLS 602 may then heat the heating module to increase the temperature of operation in step 1108 utilizing any type of controllable heat source which may include, for example, passing a controlled amount of current through a low resistive path within the heating module. The TCLS 602 then measures a change of temperature at the heating module in step 1110. The measurement of the temperature change may include measuring a second temperature of operation of the Heating Module and comparing the second temperature of operation to the initial temperature of operation. Once the change of temperature is measured, the TCLS 602 compensates the laser drive current in response to the measured change in temperature in step 1112. The TCLS 602 may compensate the laser drive current by driving a current source to produce the compensated laser drive current based on predetermined values determined by the type of laser utilized. The TCLS 602 then measures the laser drive current with the measurement module 612 and in step 1116 the TCLS 602 determines whether the laser drive current is correct. The process then ends in step 1010.

In another example of operation, the measurement module 612 in the TCLS 602 may measure a first laser current signal from an output laser driver 608, via signal path 628, to establish a reference current level without heating the heating module 614. The heating module 614 may then raise the temperature of the TCLS 602 around the temperature sensor 616 to a predetermined temperature, and measure a second laser current signal from the output laser driver 608. The measurement module 612 may then pass the measurement data corresponding to the first laser current signal and second laser current signal to the controller 610 via first and second measurement output signals 634 along signal path 622.

The controller 610 may compare the measurement data corresponding to the first laser current signal to the measurement data corresponding to the second laser current signal, and in response determine an adjustment signal based on the comparison. The controller 610 may then pass the adjustment signal 632 to the adjustable current source 606, via signal path 624, where the adjustment signal 632 adjusts the laser drive current of the laser. As an example, if the laser drive current is high enough to cause a potential hazardous condition, the adjustment signal may reduce the laser current to assure that the emitted optical radiation 516 produced by the laser is within the proper safety levels.

Alternatively, the measurement module 612 may include logic and/or circuitry capable of comparing the measurement data corresponding to the first laser current signal to the measurement data corresponding to the second laser current signal within the measurement module 612, and producing a measurement output signal including the comparison that is passed to the controller 610 via signal path 622.

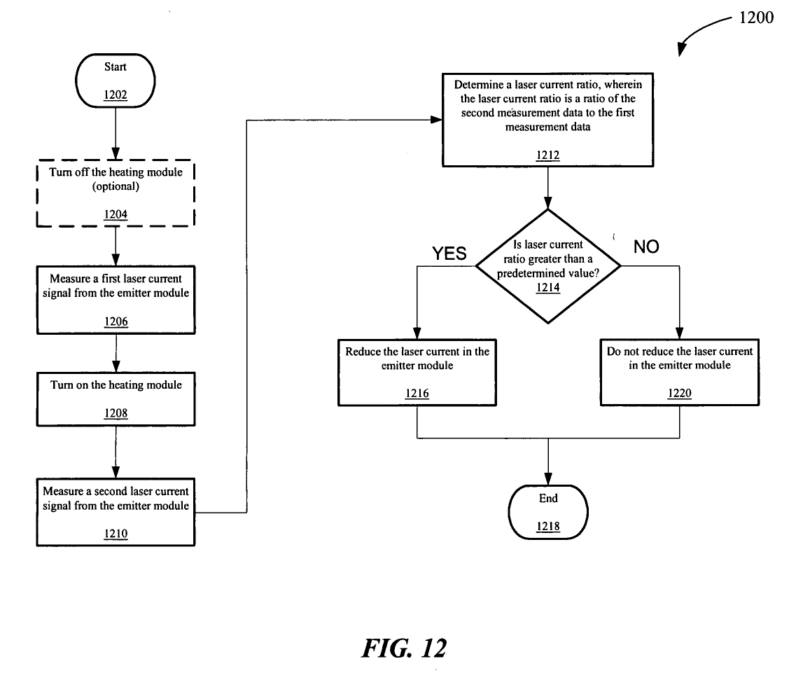

In FIG. 12, a flowchart diagram 1200 of another example process performed by TCLS 502 is shown. The process starts in step 1202, and in optional step 1204, the heating module 614 is turned off by either the TCLS 602 or the controller 610 if the heating module 614 was originally on. The measurement module 612 then measures the first laser current signal from the output laser driver 608, via signal path 628 in step 1206. The heating module 614 is then turned on in step 1208 by either the TCLS 602 or the controller 610, and after a predetermined temperature is reached, the measurement module 612 then measures the second laser current signal from the output laser driver 608, via signal path 628 in step 1210.

The measurement data from the first and second laser current signals is then passed to the controller 610 and the controller 610 determines a laser current ratio, where the laser current ratio is a ratio of the second measurement data to the first measurement data. The laser current ratio is compared to a predetermined value by the controller 610 in decision step 1214. If the laser current ratio is greater than the predetermined value, the process continues to step 1216 where the controller 610 produces an adjustment signal 632 that reduces the laser drive current produced by the adjustable current source 606. The process then ends in step 1218.

If, instead, the laser current ratio is less than or equal to than the predetermined value, the process continues to instead to step 1220 where the controller 610 produces an adjustment signal 632 that does not reduce the laser drive current in the adjustable current source 606. The process again ends in step 12186. It is appreciated by those skilled in the art that if the laser current ratio is less than or equal to than the predetermined value, the controller 610 may not actually produce an adjustment signal 632 because no adjustment is needed in the laser drive current of the adjustable current source 606.

Persons skilled in the art will understand and appreciate that one or more processes, sub-processes, or process steps described in FIGS. 10, 11 and 12 may be performed by hardware and/or software. Additionally, the controller 610 may be implemented completely in software that would be executed within a microprocessor, general purpose processor, combination of processors, digital signal processor (“DSP”), and/or application specific integrated circuit (“ASIC”). If the process is performed by software, the software may reside in software memory in the controller. The software in software memory may include an ordered listing of executable instructions for implementing logical functions (i.e., “logic” that may be implemented either in digital form such as digital circuitry or source code or in analog form such as analog circuitry or an analog source such an analog electrical, sound or video signal), and may selectively be embodied in any computer-readable (or signal-bearing) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “computer-readable medium” and/or “signal-bearing medium” is any means that may contain, store, communicate, propagate, or transport the program for use by or in connection with the instruction execution system, apparatus, or device. The computer readable medium may selectively be, for example but not limited to, an electronic, magnetic, optical, electromagnetic, infrared, or semiconductor system, apparatus, device, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

It will be understood that the foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed:

1. A Temperature Compensated Laser System (“TCLS”) for producing a temperature compensated laser drive current for a laser in an optical navigation device, the TCLS comprising:
a controller in signal communication with an adjustable current source, wherein the adjustable current source produces the temperature compensated laser drive current; and
a measurement module in signal communication with the controller and the adjustable current source,
wherein the controller adjusts the temperature compensated laser drive current produced by the adjustable current source responsive to a change in operating temperature of the TCLS.

2. The TCLS of claim 1, wherein the controller further includes:
a heating module having a temperature sensor, wherein the heating module is configured to heat the TCLS and the temperature sensor is configured to measure a change in operating temperature of the TCLS; and
a temperature compensation module in signal communication with the temperature sensor and the adjustable current source, wherein the temperature compensation module is configured to adjust the adjustable current source so as to produce the temperature compensated laser drive current that is responsive to the change in operating temperature of the TCLS.

3. The TCLS of claim 2, wherein the measurement module is configured to measure the temperature compensated laser drive current and produce in response a laser driver current measurement output signal having laser driver current measurement data.

4. The TCLS of claim 3, wherein the temperature compensation module adjusts the temperature compensated laser drive current produced by the adjustable current source responsive to the laser driver current measurement data.

5. The TCLS of claim 3, wherein the temperature compensation module adjusts the adjustable current source by a predetermined value in response to the change in operating temperature of the TCLS.

6. The TCLS of claim 5, wherein the optical navigation device is a computer mouse.

7. The TCLS of claim 6, wherein the laser is a Vertical Cavity Semiconductor Emitting Laser (“VCSEL”).

8. A Temperature Compensated Laser Driver (“TCLD”) for producing a temperature compensated laser drive current for a laser in an optical navigation device, the TCLD comprising:
an adjustable current source that produces the temperature compensated laser drive current;
a controller in signal communication with the adjustable current source; and
a measurement module in signal communication with the controller and the adjustable current source,
wherein the controller adjusts the temperature compensated laser drive current produced by the adjustable current source responsive to a change in temperature of the TCLD.

9. The TCLD of claim 8, wherein the controller further includes:
a heating module having a temperature sensor, wherein the heating module is configured to heat the TCLD and the temperature sensor is configured to measure a change in temperature of the TCLD; and
a temperature compensation module in signal communication with the temperature sensor and the adjustable current source, wherein the temperature compensation module is configured to adjust the adjustable current source so as to produce the temperature compensated laser drive current that is responsive to the change in temperature of the TCLD.

10. The TCLD of claim 9, wherein the measurement module is configured to measure the temperature compensated laser drive current and produce in response a laser driver current measurement output signal having laser driver current measurement data.

11. The TCLD of claim 10, wherein the temperature compensation module adjusts the temperature compensated laser drive current produced by the adjustable current source responsive to the laser driver current measurement data.

12. The TCLD of claim 10, wherein the temperature compensation module adjusts the adjustable current source by a predetermined value in response to the change in operating temperature of the TCLD.

13. The TCLD of claim 12, further including an output laser driver.

14. The TCLD of claim 12, wherein the optical navigation device is a computer mouse.

15. A method for compensating for temperature variations in an optical navigation device having a laser and Temperature Compensated Laser Driver (“TCLD”), the method comprising:
measuring a change of operating temperature of the TCLD within the optical navigation device; and
producing a temperature compensated laser drive current in response to the change in operating temperature of the TCLD.

16. The method of claim 15, wherein producing a temperature compensated laser drive current includes adjusting a temperature compensated laser drive current by a predetermined value in response to the change in operating temperature.

17. The method of claim 16, further including measuring a first temperature of operation of the TCLD.

18. The method of claim 17, further including:
measuring a first temperature compensated laser drive current;
heating the heating module to a second temperature of operation;
measuring a change of temperature from the first temperature of operation to the second temperature of operation;
measuring a second temperature compensated laser drive current; and
determining whether the measured second temperature compensated laser drive current corresponds to the predetermined value.

19. The method of claim 17, further including:
measuring a first temperature compensated laser drive current;
heating the heating module to a second temperature of operation;
measuring a change of temperature from the first temperature of operation to the second temperature of operation;
measuring a second temperature compensated laser drive current;
comparing the first temperature compensated laser drive current to the second temperature compensated laser drive current; and
determining a current adjustment signal based on the comparison.

20. The method of claim 19, further including:
adjusting the temperature compensated laser drive current produced by a adjustable current source with the current adjustment signal;
producing a first measurement output signal in response to measuring the first temperature compensated laser drive current, the first measurement output signal having first measurement data;
producing a second measurement output signal in response to measuring the second temperature compensated laser drive current, the second measurement output signal having second measurement data; and
wherein comparing the first temperature compensated laser drive current to the second temperature compensated laser drive current includes
determining a laser current ratio, wherein the laser current ratio is a ratio of the second measurement data to the first measurement data, and
comparing the laser current ratio to a predetermined value.

21. The method of claim 20, wherein determining a current adjustment signal includes
setting a first threshold value when the laser current ratio is greater than the predetermined value,
setting a second threshold value when the laser current ratio is not greater than the predetermined value, and
wherein the magnitude of the current adjustment signal is determined by the first threshold value and the second threshold value.

22. The method of claim 21, wherein the temperature compensated laser drive current drives a Vertical Cavity Semiconductor Emitting Laser (“VCSEL”).
